(19) United States
(12) Patent Application Publication
(10) Pub. No.: US 2026/0070807 A1
(43) Pub. Date: Mar. 12, 2026

(54) PRECURSOR FOR PREPARATION OF CATHODE ACTIVE MATERIAL

(71) Applicant: L&F CO., LTD., Daegu (KR)

(72) Inventors: Su Yeol YOON, Daegu (KR); Hyun Do JEONG, Daegu (KR); Sun Hong PARK, Daegu (KR); Sung Kyun CHANG, Daegu (KR); Jae Hak JEONG, Daegu (KR)

(21) Appl. No.: 19/108,798

(22) PCT Filed: Sep. 18, 2023
(86) PCT No.: PCT/KR2023/014079

§ 371 Date: Mar. 5, 2025

(30) Foreign Application Priority Data
Sep. 19, 2022 (KR) 10-2022-0117606
Sep. 19, 2022 (KR) 10-2022-0117609

(51) Int. Cl. C01G 53/504

(52) U.S. Cl. CPC C01G 53/504; C01P 2004/03; C01P 2006/40

(57) ABSTRACT

Disclosed is a precursor for preparing a cathode active material, more specifically, a precursor for preparing a cathode active material including a center portion and a surface portion sequentially formed from a center of a particle toward an outer surface, wherein the surface portion has a lower density than the center portion.

### CROSS-REFERENCE TO RELATED APPLICATIONS

This application claims the benefit of Korean Patent Applications No. 10-2022-0117606 and No. 10-2022-0117609 on Sep. 19, 2022, respectively, with the Korean Intellectual Property Office, the disclosure of which is herein incorporated by reference in its entirety.

### TECHNICAL FIELD

The present invention relates to a precursor for preparation of a cathode active material and more particularly, to a precursor that has a configuration in which a surface portion has a lower density than a center portion, and thus provides excellent cycle life and thermal stability as well as high charge/discharge efficiency when prepared into a cathode active material.

### BACKGROUND ART

As the use of fossil fuels with limited reserves has caused a global environmental pollution issue, the use of eco-friendly secondary battery systems is increasing. For example, the demand for energy sources such as electronic devices, electric vehicles (EVs), and energy storage systems (ESSs) is increasing and the performance requirements of secondary battery systems are also increasing.

In order to manufacture lithium-ion batteries (LIBs), which are a representative example of secondary batteries, with high performance and high efficiency, improvements in high-capacity energy density, cycle life, and safety characteristics are required.

As the demand for secondary batteries increases and the demand for battery raw materials increases, the prices of major materials such as nickel (Ni), cobalt (Co), and lithium (Li) are rising. Therefore, the development of low-cost, high-performance cathode active materials is actively underway.

As a representative example, low Ni-based cathode active materials having a low Ni content did not cause any problems, excluding low capacity and output, but require performance improvement. Development of high-efficiency, low-cost cathode active materials is possible as the Ni content increases.

However, high Ni-based cathode active materials having a Ni content of 70% or more undergo a decrease in capacity upon repeated charge and discharge, which is caused by problems such as shrinkage of the crystal structure, oxygen release, cation mixing, and gelation due to rapid changes in volume during charge and discharge.

In an attempt to solve such a decrease in capacity, some prior art disclose active material particles having a dual structure of inner and outer parts, wherein these parts have different properties or compositions.

First, as an example of technologies that change properties, Korean Patent Publication No. 2018-0063857 discloses a precursor particle having a configuration in which a dense intermediate layer having a low porosity is interposed between a porous core and a porous shell to easily remove stress due to volume changes that occur during lithium intercalation and deintercalation, and shorten the diffusion distance of lithium ions.

In addition, Korean Patent Publication No. 2022-0081312 discloses a secondary particle precursor for a cathode active material including a core and a shell to produce secondary particles with improved resistance characteristics through an increase of the average particle diameter (D50) of primary large particles and an increase of the grain size thereof, wherein the secondary particle precursor has a D50 of 6±2 μm, the core has a D50 of 1 to 5 μm, and the core is more porous than the shell.

Similarly, Korean Patent Publication No. 2019-0070458 discloses a secondary battery cathode active material including a core-shell structure that is capable of increasing the capacity per volume of the secondary battery by reducing the amount of conductive material and binder to be mixed with cathode and anode active materials during electrode manufacturing and of improving the capacity and output characteristics of the secondary battery cathode by increasing the relative diffusion distance or speed of lithium ions generated during charge and discharge, wherein the core has a porous nanostructure having a particle size of 100 nm or less, the shell has a bulk structure having a particle size of 1 μm or more, and the core and the shell have different contents of nickel, cobalt, and manganese.

As an example of technologies for different compositions, Korean Patent Publication No. 2016-0052428 discloses a transition metal oxide precursor including a core having a high nickel content and a shell having a high cobalt content, in order to provide excellent capacity and improved output.

In addition, Korean Patent Publication No. 2021-0097057 discloses a cathode active material precursor having a composition containing Co, Mn, and Al in addition to Ni, to greatly improve lifespan characteristics and resistance increase, wherein the precursor includes secondary particles in which a plurality of primary particles are aggregated, the long axes of the primary particles are arranged in a direction from the center of the secondary particles toward the surface, and the primary particles include crystal grains with a plane (001) parallel to the long axes of the primary particles.

In addition, Korean Patent Publication No. 2022-0098994 discloses a cathode active material precursor having a secondary particle including a center portion and a surface portion, so as to provide excellent structural stability and improved cycle lifespan, wherein the surface portion includes a primary particle coated with manganese oxide, manganese hydroxide, or a mixture thereof, and the precursor has a concentration gradient in which a concentration of manganese in the surface portion gradually decreases from the outermost surface toward the center portion.

However, it has been found that the cathode active materials prepared using the technologies described above only improve some of the characteristics of secondary batteries, and in particular, do not provide the high charge/discharge efficiency that has recently become increasingly required, and the overall characteristics such as cycle life and structural stability do not reach the desired level.

Therefore, there is an increasing need for a novel technology that can solve these problems at once.

### DISCLOSURE

### Technical Problem

The present invention has been made to solve the above problems and other technical problems that have yet to be resolved.

The present inventors have examined the problems of the prior art in various ways, and in particular, have considered the causes of low charge/discharge efficiency from various aspects. As a result, the present inventors have predicted that the low charge/discharge efficiency is caused by the ineffective diffusion of lithium to the center of the cathode active material during charge/discharge of the secondary battery. As a result of in-depth research and various experiments, the present inventors have found that the problem can be solved through structural change of the precursor rather than the cathode active material, and have completed the present invention.

### Technical Solution

The above and other objects can be accomplished by the provision of a precursor for preparing a cathode active material including a center portion and surface portion sequentially formed from a center of a particle toward an outer surface, wherein the surface portion has a lower density than the center portion.

The present inventors have found that, since the center portion has a relatively high density, the structural stability is excellent even after repeated charging and discharging, and the occurrence of cracks is suppressed, so the cycle lifespan and thermal stability are excellent. In particular, since the surface portion has a relatively low density, lithium can easily diffuse to the center when the precursor is mixed with a lithium-containing precursor and fired for the preparation of a cathode active material, so that the charge and discharge efficiency of the secondary battery is excellent.

In one specific example, the difference in the density between the surface portion and the center portion may be caused by a difference in porosity therebetween. Due to the significant difference in porosity, the surface portion may be composed of a porous structure with high porosity.

In the density difference, the density ratio of the surface portion to the center portion (surface density/center density) may be in the range of 0.1 to 0.95. The minimum and maximum density ratios may determine the sizes that set the upper and lower ranges of the density difference to effectively provide the characteristics described above.

The center and the surface portions having such a density difference may have different material compositions.

In one specific example, the center portion may include an element composition represented by the following Formula 1, and the surface portion may include an element composition represented by the following Formula 2:

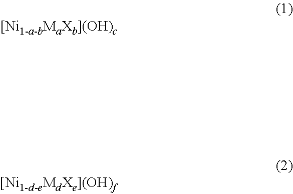

wherein a, b and c satisfy 0≤a≤1, 0≤b<0.5, and 1≤c≤3;
d, e and f satisfy 0≤d≤1, 0<e≤0.5, and 1≤f≤3;
b and e satisfy b<e;
M includes at least one transition metal element stable in 4-coordination or 6-coordination; and
X includes at least one element selected from the group consisting of Al, Zr, Mg, B, Ti, Zn, Sn, Ca, Ge, Ga, Nb, Mo, and W.

The result of in-depth research and review of the present inventors showed that, when the center and surface portions of the precursor particles include specific element compositions as described above, the surface portion has a lower density than the center portion.

For example, the material for the center portion may contain Ni at 50% or more, preferably 70% or more, on a molar basis, based on the total content of elements excluding oxygen and hydrogen, and may optionally contain Mn and/or Co.

On the other hand, the material for the surface portion may contain Ni at 50% or more, preferably 70% or more, on a molar basis, based on the total content of elements excluding oxygen and hydrogen, and containing element X at 20% or less, preferably 10% or less, and may optionally contain Mn and/or Co. The element X is as defined in the formulas above, and is Al in one preferred example.

As can be seen from the difference in composition described above, the surface portion contains element X, and as a result, the density of the surface portion may be set lower than that of the center portion.

In one specific example, the content of element X in the surface portion may be in the range of 1,000 to 10,000 ppm. When the content of element X is excessively low, it may be difficult to form a surface portion having a lower density than the center portion, and on the other hand, when the content is excessively high, the particles may not grow during the precursor preparation process, and thus the desired precursor particles may not be formed, which is not preferable.

The element X contained in the surface portion may, depending on the types of the elements described above, act as an electrochemically inactive element during charge/discharge of the cathode active material prepared from the precursor, thereby preventing collapse of the structure and forming a protective layer on the particle surface to suppress side reactions with the electrolyte and contribute to the improvement in surface stability.

As defined above, the center portion may not basically contain an element X, but may contain an element X in an amount lower than the surface portion. In the latter case, it has been found that, when element X is contained in an amount of 1,000 ppm or less, a phase in which the density of the center portion is greater than that of the surface portion may be formed.

The difference in density between the center and the surface portions causes an overall discontinuous difference in the concentration of element X at the interface therebetween. That is, the concentration of element X does not have a continuous concentration gradient at the interface, but has a sharp concentration change like a step shape.

On the other hand, element X at the surface portion may be uniformly distributed throughout the surface portion without a concentration change, or may be distributed with various concentration gradients as follows:
(i) a concentration gradient in which the concentration increases toward the center of the precursor particle;
(ii) a concentration gradient in which the concentration decreases toward the center of the precursor particle;
(iii) a concentration gradient in which the concentration increases toward the center of the precursor particle and then decreases; and
(iv) a concentration gradient in which the concentration decreases toward the center of the precursor particle and then increases.

However, a great difference in concentration between regions at the surface portion may make it difficult to form a precursor having the desired characteristics of the present invention. Therefore, in one preferred example, there is a difference in the concentration of element X between a maximum concentration region and a minimum concentration region based on an average concentration of 5% or less, more preferably 1% or less. That is, in terms of the overall surface portion, more effective Li diffusion is possible when there is a uniform density difference of 5% or less. Therefore, more preferably, the concentration gradient of element X is 5% or less.

In one specific example, the ratio of the center portion to surface portion (center portion:surface portion) based on the diameter of the precursor particle may be in the range of 3:7 to 9:1. When the ratio is excessively small, that is, when the size of the center portion is excessively small, cracks may occur during charge/discharge of the cathode active material, which may significantly reduce the cycle lifespan. On the other hand, when the ratio is excessively large, that is, when the size of the surface portion is excessively small, the ease of lithium diffusion may decrease, which may lower the charge/discharge efficiency, which is not preferable. Preferably, the ratio may be in the range of 5:5 to 6:4.

The size of the precursor particle may be, for example, 3 to 20 μm.

As can be seen from the experiment described below, a precursor having such a dual structure may be prepared by changing the type of aqueous metal salt solution in the coprecipitation reaction. For example, assuming that a precursor having a diameter of 10 μm is to be prepared, a core particle corresponding to the center portion is prepared by performing a co-precipitation reaction using an aqueous metal salt solution (A) having a composition constituting a center portion until the diameter becomes, for example, 6 μm, and then a precursor particle including a center portion having a diameter of 6 μm and a surface portion having a diameter of 4 μm is prepared by performing a co-precipitation reaction until the diameter becomes 10 μm using an aqueous metal salt solution (B) having a composition constituting a surface portion, instead of the aqueous metal salt solution (A).

The present invention also provides a cathode active material prepared by mixing the precursor with a lithium precursor and then firing the mixture, and a secondary battery including the cathode active material.

The method for preparing the cathode active material is known in the art, and the composition and manufacturing method of the secondary battery are also known in the art, and thus a detailed description thereof will be omitted herein.

### Effects of the Invention

As described above, the precursor for preparing a cathode active material according to the present invention is formed such that the center and the surface portions have different densities, to provide excellent structural stability even after repeated charge and discharge, to suppress the occurrence of cracks, provide excellent cycle lifespan and thermal stability, to allow lithium to easily diffuse to the center portion when a mixture of the precursor with a lithium-containing precursor is fired for preparation of the cathode active material and to provide excellent charge and discharge efficiency.

### DESCRIPTION OF DRAWINGS

The above and other objects, features and other advantages of the present invention will be more clearly understood from the following detailed description taken in conjunction with the accompanying drawings, in which:

FIGS. 1A and 1B are cross-sectional SEM images of a precursor prepared in Example 1;

FIGS. 2A to 2C are cross-sectional SEM images of a precursor prepared in Example 2;

FIGS. 3A and 3B are cross-sectional SEM images of a precursor prepared in Example 3;

FIGS. 4A and 4B are cross-sectional SEM images of a precursor prepared in Comparative Example 1;

FIGS. 5A and 5B are cross-sectional SEM images of a precursor prepared in Comparative Example 2; and

FIGS. 6A and 6B are cross-sectional SEM images of a precursor prepared in Comparative Example 3.

### BEST MODE

Now, exemplary embodiments of the present invention will be described in detail with reference to the accompanying drawings. It should be noted, however, that the scope of the present invention is not limited by the illustrated embodiments.

### Example 1

An aqueous metal salt solution having a composition of Ni:Co:Mn 75:10:15 was continuously supplied to a 30 L cylindrical reactor along with aqueous ammonia and an aqueous sodium hydroxide solution, and the ammonia concentration in the reactor was adjusted to 3,000 to 5,000 ppm and the pH was adjusted to 11.6 to 11.7. A co-precipitation reaction was performed at a stirring speed of 500 rpm and at 60° C. until the average particle size (D50) became 6 μm, to prepare a core particle corresponding to the center portion of the precursor.

Then, in the reactor containing the core particle, the aqueous metal salt solution was changed to an aqueous metal salt solution having a composition of Ni:Co:Mn 75:10:15+Al 3,000 ppm, continuously supplied along with aqueous ammonia and an aqueous sodium hydroxide solution, and synthesized until the D50 became 10 μm, to prepare a precursor including a surface portion in addition to the core particle in the center portion. The ammonia concentration, pH, rpm, and temperature in the reactor were set to the same conditions as above.

The synthesized precursor was dried at 120° C. for 20 hours after washing and filtrate separation. As a result, a composite transition metal hydroxide powder with a D50 of 10 μm was prepared.

The cross-section of the prepared precursor powder was imaged using a scanning electron microscope (SEM). It can be seen from the image that the precursor powder had a structure in which a ratio of the center portion to the surface portion was 6:4 based on the diameter and the center portion had a higher density than the surface portion.

### (Preparation of Cathode Active Material)

LiOH as a lithium raw material and ZrO₂ as a raw material for a doping material Zr calculated at specific contents were injected into a 10 L cylindrical reactor and then mixed with the precursor prepared above in a dry manner. Then, 4.0 kg of the mixture was charged in a saggar made of mullite, and a jig was taken on the mixture to the bottom so that the atmospheric conditions could penetrate well to the bottom of the saggar. In addition, in order to create a saggar atmosphere suitable for the firing of the active material, specific exhaust conditions and oxygen (O₂) flow rates were set, and the firing was performed for a total of 24.0 to 36.0 hours for heating, holding, and cooling.

After the firing, the active material in the cake was pulverized to a size suitable for fine pulverization through a coarse pulverization process and pulverized to have a constant particle size distribution under the pulverization/screening conditions of 1,300 rpm/2,000 rpm in an ACM pulverizer including a rotor blade and a separation blade. Then, the particles were filtered out through a sieve to adjust the particle size to about 10 μm and thereby prepare a cathode active material having excellent durability using a precursor having a specific grain size of Example 1.

2 wt % or less of lithium is present in the form of byproducts of LiOH and Li₂CO₃ on the surface of the prepared active material. Since the residual lithium adversely affects the electrode manufacturing and electrochemical characteristics, the active material was washed to remove the residual lithium. For this purpose, the prepared cathode active material was stirred in distilled water at about 15 to 45° C. with a solid content of 50 to 80% in a 20 L constant temperature water bath for about 30 seconds, the stirred slurry was filtered through a filter device, and the filtered product thus obtained was dried in a dryer at 100° C. for 12 hours or more.

To perform mixing with H₃BO₃, firing and boron coating, the washed and dried product was mixed with H₃BO₃ in a 10 L cylindrical mixer for 20 minutes. The resulting mixture was charged in an about 0.5 to 1 kg of the same saggar used for the main firing and fired in an oxygen (O₂) atmosphere saggar at 300 to 400° C. for a total of 12.0 to 20.0 hours for heating, holding, and cooling.

### Example 2

A precursor was synthesized in the same manner as in Example 1, except that an Al content was changed to 6,000 ppm during the formation of the surface portion, and an SEM image was obtained to validate the composite cross-sectional structure of the precursor. Then, a cathode active material was prepared in the same manner as in Example 1.

### Example 3

An aqueous metal salt solution having a composition of Ni:Mn 75:25 was continuously supplied to a 30 L cylindrical reactor along with aqueous ammonia and an aqueous sodium hydroxide solution, and the ammonia concentration in the reactor was adjusted to 3,000 to 5,000 ppm and the pH was adjusted to 11.6 to 11.7. A co-precipitation reaction was performed at a stirring speed of 500 rpm and at 60° C. until the average particle size (D50) became 6 μm, to prepare a core particle corresponding to the center portion of the precursor.

Then, in the reactor containing the core particle, the aqueous metal salt solution was changed to an aqueous metal salt solution having a composition of Ni:Co:Mn 75:10:15+Al 3,000 ppm, continuously supplied along with aqueous ammonia and an aqueous sodium hydroxide solution, and synthesized until the D50 became 10 μm, to prepare a precursor including a surface portion in addition to the core particle in the center portion. The ammonia concentration, pH, rpm, and temperature in the reactor were set to the same conditions as above.

The synthesized precursor was dried at 120° C. for 20 hours after washing and filtrate separation. As a result, a composite transition metal hydroxide powder with a D50 of 10 μm was prepared. Then, the cathode active material was prepared in the same manner as in Example 1.

The cross-section of the prepared precursor powder was imaged using a scanning electron microscope (SEM). It can be seen from the image that the precursor powder had a structure in which a ratio of the center portion to the surface portion was 6:4 based on the diameter and the center portion had a higher density than the surface portion.

### Example 4

A precursor was synthesized in the same manner as in Example 1, except that an Al content was changed to 6,000 ppm during the formation of the surface portion, and an SEM image was obtained to validate the composite cross-sectional structure of the precursor. Then, a cathode active material was prepared in the same manner as in Example 1.

### Comparative Example 1

An aqueous metal salt solution having a composition of Ni:Co:Mn 75:10:15 was continuously supplied to a 30 L cylindrical reactor along with aqueous ammonia and an aqueous sodium hydroxide solution, the ammonia concentration in the reactor was adjusted to 3,000 to 5,000 ppm and the pH was adjusted to 11.6 to 11.7. A co-precipitation reaction was performed at a stirring speed of 500 rpm and at 60° C. until the average particle size (D50) became 10 μm to synthesize a precursor. The synthesized precursor was dried at 120° C. for 20 hours after washing and filtrate separation to prepare a composite transition metal hydroxide powder. Then, a cathode active material was prepared in the same manner as in Example 1.

The cross-section of the prepared precursor powder was imaged using a scanning electron microscope (SEM). It can be seen from the image that the precursor powder had a single structure without distinction between the center portion and the surface portion, and thus there was virtually no difference in density between the center portion and the surface portion.

### Comparative Example 2

An aqueous metal salt solution having a composition of Ni:Mn=75:25 was continuously supplied to a 30 L cylindrical reactor along with aqueous ammonia and an aqueous sodium hydroxide solution, the ammonia concentration in the reactor was adjusted to 3,000 to 5,000 ppm and the pH was adjusted to 11.6 to 11.7. A co-precipitation reaction was performed at a stirring speed of 500 rpm and at 60° C. until the average particle size (D50) became 10 μm to synthesize a precursor. The synthesized precursor was dried at 120° C. for 20 hours after washing and filtrate separation to prepare a composite transition metal hydroxide powder. Then, a cathode active material was prepared in the same manner as in Example 1.

The cross-section of the prepared precursor powder was imaged using a scanning electron microscope (SEM). It can be seen from the image that the precursor powder had a single structure without distinction between the center portion and the surface portion, and thus there was virtually no difference in density between the center portion and the surface portion.

### Comparative Example 3

A precursor was synthesized in the same manner as in Example 1, except that, from the beginning, an aqueous metal salt solution with a composition of Ni:Co:Mn 75:10:15+Al 3000 ppm was injected into the reactor, and an SEM image was obtained to validate the composite cross-sectional structure of the precursor. Then, a cathode active material was prepared in the same manner as in Example 1.

### [Experimental Example 1] Precursor Cross-Section SEM-EDX Analysis

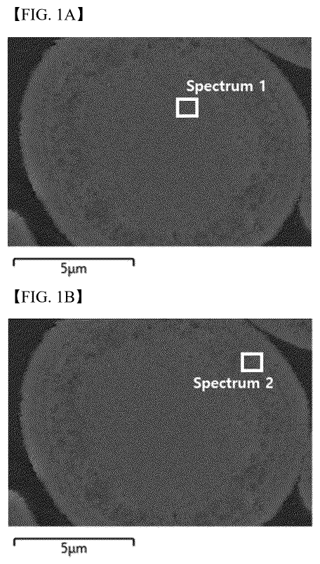

The cross-sections of the precursors prepared in Examples 1 to 3 and Comparative Examples 1 to 3 were imaged using a scanning electron microscope (SEM) and an energy dispersive X-ray spectrometer (EDX) under the following conditions, and the results are shown in FIGS. 1 to 6 and Table 1 below.

### [SEM Measurement Conditions]

Model: HITACHI (S-4800)
Resolution: 1.0 nm 15 kV, 1.5 nm 1 kV
Magnification: ×10,000
Electron gun: Cold-cathode field emission type electron gun
Accelerating voltage: 15 kV
Detector: SE (BSE)

TABLE 1

| | | Al | Mn | Co | Ni | Total |
|---|---|---|---|---|---|---|
| | Item | (wt %) | (wt %) | (wt %) | (wt %) | (wt %) |
| Example 1 | Spectrum 1 | 0 | 14.7 | 9.92 | 75.38 | 100 |
| | Spectrum 2 | 0.31 | 14.85 | 9.69 | 75.15 | 100 |
| Example 2 | Spectrum 1 | 0 | 14.69 | 9.9 | 75.41 | 100 |
| | Spectrum 2 | 0.6 | 14.64 | 10 | 74.76 | 100 |
| Example 3 | Spectrum 1 | 0 | 24.65 | 0 | 75.35 | 100 |
| | Spectrum 2 | 0.28 | 24.81 | 0 | 74.91 | 100 |
| Comparative | Spectrum 1 | 0 | 14.69 | 9.98 | 75.33 | 100 |
| Example 1 | Spectrum 2 | 0 | 15.18 | 9.87 | 74.95 | 100 |
| Comparative | Spectrum 1 | 0 | 24.67 | 0 | 75.33 | 100 |
| Example 2 | Spectrum 2 | 0 | 25.08 | 0 | 74.92 | 100 |
| Comparative | Spectrum 1 | 0.29 | 14.5 | 9.9 | 75.31 | 100 |
| Example 3 | Spectrum 2 | 0.28 | 14.92 | 9.9 | 74.9 | 100 |

As can be seen from FIGS. 1A and 1B, which are cross-sectional SEM images of the precursor prepared in Example 1, the high-density center portion can be clearly distinguished from the relatively low-density surface portion. Through this structure, when the precursor of the present invention is mixed with a lithium-containing precursor, followed by firing, in the process of preparing a cathode active material, it can easily diffuse to the center portion and react therewith, thereby preparing a cathode active material with excellent charge/discharge efficiency.

As can be seen from Table 1 above, there is a difference in Al content between Spectrum 1 corresponding to the high-density center portion of Example 1 and Spectrum 2 corresponding to the low-density surface portion. As such, the precursor of the present invention may have a difference in the content of a specific transition metal between the center portion and the surface portion, and may have a discontinuous concentration that gradually increases from the center portion toward the surface portion.

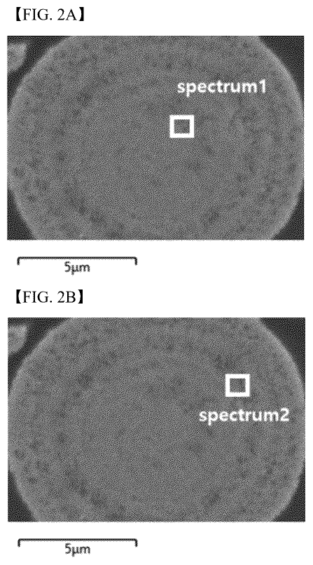

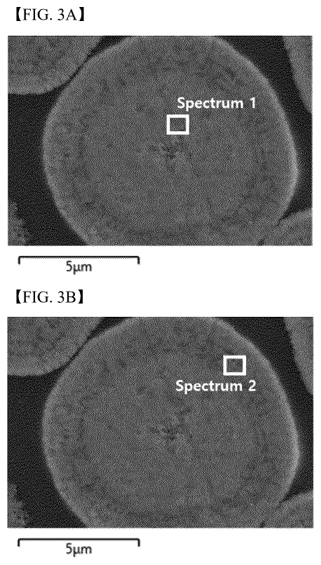

FIGS. 2A and 2B, and FIGS. 3A and 3B are cross-sectional SEM images of precursors prepared in Examples 2 and 3, respectively. Al is not detected in Spectrum 1 corresponding to the relatively high-density center portion, whereas Al is detected in Spectrum 2 corresponding to the relatively low-density surface portion. Like in Example 1, it can be seen that, in Examples 2 and 3, the surface portion where Al is detected has a lower density than the center portion.

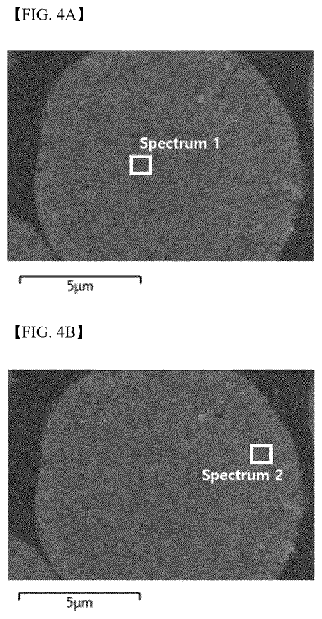

FIGS. 4A to 6B are cross-sectional SEM images of precursors prepared in Comparative Examples 1 to 3.

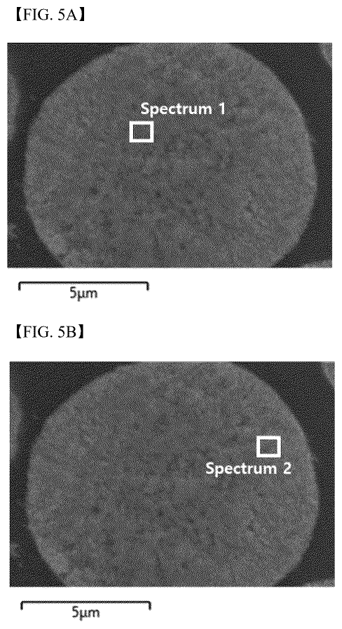

As can be seen from FIGS. 4A and 4B, and FIGS. 5A and 5B, when Al is not added during the precursor preparation process, no distinct structure distinguishing the center portion from the surface portion is visible and the entire structure is formed as a dense structure. Such a structure may have lower charge/discharge efficiency compared to the embodiment of the present invention because lithium does not easily diffuse to the center portion when the precursor is mixed with a lithium-containing precursor, followed by firing for the preparation of a cathode active material.

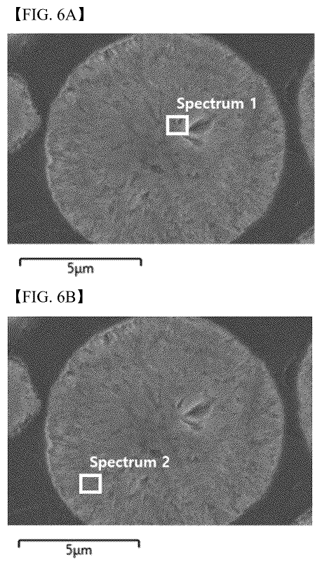

FIGS. 6A and 6B are cross-sectional SEM images of the precursor of Comparative Example 3 prepared by adding all raw materials to the reactor during the precursor preparation process. As in Comparative Example 3, when Al is added from the beginning, the high-density center portion and the low-density surface portion are not formed separately. In terms of the Al content of Spectrum 1 and Spectrum 2 of Comparative Example 3, the Al content is uniformly distributed throughout the precursor and thus a porous structure is overall formed throughout the precursor.

Therefore, in order to form a dense structure in the center portion, it is preferable that Al is not contained in the center portion or is contained in a small amount. When Al is excessively contained in the center portion, excessive pores are created, which reduces the density. This causes a decrease in particle strength after preparation of a cathode active material, and cracks may occur during charge and discharge, which may significantly reduce the cycle lifespan. Therefore, when the total content of the transition metal and Al in the center portion is 100 wt %, for example, the Al content is preferably less than 0.2 wt %, and more preferably less than 0.1 wt %.

### [Experimental Example 2] Measurement of Residual Lithium

The amount of residual lithium of the cathode active materials prepared using the precursors of Examples 1 to 4 and Comparative Examples 1 to 3 is shown in Table 2 below.

The amount of residual lithium was measured under the following conditions. 5 g±0.02 g of a sample was added to a beaker containing 100 g of distilled water and a magnetic bar, and stirred for 10 minutes. Then, the stirred sample was filtered through filter paper, and the filtered filtrate was placed in a beaker to perform titration. The titrant was 0.1 N HCl, air bubbles were removed from the cylinder, and DET (dynamic equivalence point titrations) was used as a titrant dispensing method. The titration was automatically completed under the condition of pH 2.5, the calculation was performed according to FP (1)=4.5, EP (1), and the titration speed was set to a maximum level to measure the residual lithium.

TABLE 2

| | Residual lithium (ppm) | | | |
|---|---|---|---|---|
| Item | Li₂CO₃ | LiOH | Total | ΔPSD |
| Example 1 | 143 | 268 | 411 | 3.48 |
| Example 2 | 127 | 195 | 322 | 3.67 |
| Example 3 | 179 | 431 | 610 | 4.41 |
| Example 4 | 312 | 283 | 595 | 4.82 |
| Comparative Example 1 | 382 | 387 | 769 | 8.48 |
| Comparative Example 2 | 592 | 398 | 990 | 6.8 |
| Comparative Example 3 | 341 | 371 | 712 | 5.9 |

As can be seen from Table 2 above, when the residual lithium of the cathode active materials prepared using the precursors of Examples 1 to 4 was compared with the residual lithium of the cathode active materials prepared using the precursors of Comparative Examples 1 to 3, it can be seen that the amount of residual lithium of the cathode active materials prepared using the precursors of Examples 1 to 4 is small. This is presumed to be because, when preparing the cathode active materials, lithium easily diffuses into the precursor and reacts therewith due to the porous surface structure of the precursors of Examples 1 to 4, thus reducing the amount of lithium remaining unreacted after firing on the surface of the cathode active materials.

On the other hand, in Comparative Examples 1 to 2, there is no porous structure on the surface of the precursor and thus the amount of lithium that does not diffuse into the precursor and remains on the surface during the preparation of the cathode active materials is relatively large. As a result, when the cathode active materials are prepared using the corresponding precursors, lithium may not move smoothly into the cathode active materials during charging and discharging, which may cause a problem in which the charge and discharge efficiency is reduced. In addition, when a high amount of lithium remains on the surface of the cathode active material, additional problems such as gelation may occur. Therefore, preferably, residual lithium is present in an appropriate amount.

In Comparative Example 3, a low-density structure was formed throughout the precursor and the residual lithium was greatly reduced compared to Comparative Examples 1 and 2, but the effect of Comparative Example 3 was insufficient compared to Examples 1 to 4, wherein the surface portion only had a low-density structure.

### [Experimental Example 3] APSD Measurement

The D50 of the cathode active materials prepared using the precursors of Examples 1 to 4 and the cathode active materials prepared using the precursors of Comparative Examples 1 to 3 was measured before and after pressing with a strength of 2.5 tons, and the particle size change is shown in Table 2 along with the residual lithium amount.

$$Δ PSD = [ ( D 50 after pressing ) - ( D 50 before pressing ) ] / ( D 50 before pressing ) \times 100$$

It can be seen from Table 2 above that the D50 change of Examples 1 to 4 was lower than that of Comparative Examples 1 to 3. In other words, this means that the particle breakage of the cathode active materials prepared using the precursors of Examples 1 to 4 was reduced before and after pressing, which supports that the particle is relatively strong. The reduction of particle breakage is because Al is contained in the precursor surface, the cathode active material prepared therefrom also has a porous surface, and the porous surface acts as a buffer to absorb an applied external force. In general, in order to manufacture a secondary battery electrode after preparation of the cathode active material, a process of adding the cathode active material and an additive such as a binder and then applying pressure to an electrode plate is essential. In this process, by reducing breakage of cathode active material particles, the lifespan characteristics can be improved.

On the other hand, in Comparative Examples 1 and 2, Al was not contained and thus a low-density structure was not formed inside the precursor, and the cathode active material prepared from the precursor is also formed with a dense structure overall, and thus particle breakage appears to occur relatively frequently when an external force is applied. In Comparative Example 3, since Al is uniformly contained inside the precursor, the overall structure has a low density, and the cathode active material prepared from the precursor of Comparative Example 3 also has a porous structure overall. In Comparative Example 3, particle breakage is reduced by a partial buffering action due to the porous structure compared to Comparative Examples 1 and 2, but rather, the overall particle strength was excessively weak and thus the D50 change increased compared to Examples.

Therefore, rather than forming a low-density structure using an overall uniform Al content throughout the precursor during preparation of the precursor, the center portion and the surface portion are formed, the center portion is designed to have a high density and the surface portion is designed to have a low density so the internal diffusion effect of lithium and the effect of suppressing the breakage of the cathode active material particles due to external force can be simultaneously achieved during preparation of the cathode active material.

### [Experimental Example 4]—Measurement of Battery Characteristics

PVdF as a binder, the cation active material synthesized in each of Examples 1 to 4 and Comparative Examples 1 to 3, and Super-C as a conductive material were mixed at a weight ratio of 3:95:2. The resulting mixture was homogeneously applied onto an aluminum current collector, dried at 120° C., and then rolled to produce a cathode. The prepared cathode was prepared to fit the size of a CR2032 type coin cell and a coin cell was produced using Li metal as an anode, porous polyethylene as a separator, and a solution of a lithium salt in a carbonate-based solvent as an electrolyte.

The coin cell thus produced was subjected to a charge/discharge test at a voltage of 4.3 to 2.5V at 25° C. A current density of 0.1C was applied and a 0.05C constant voltage was applied. In addition, the voltage range of the lifespan test was 4.3 to 3V, a current density of 0.5C/1C was applied for charge/discharge, a 0.05C constant voltage section was applied, and the lifespan test was conducted after 50 cycles. The test results are shown in Table 3 below.

TABLE 3

| | Cell characteristics | | | | |
|---|---|---|---|---|---|
| | CC | DC | Eff | 50th Cycle | 50th Cycle IR |
| Item | (mAh/g) | (mAh/g) | (%) | (%) | (%) |
| Example 1 | 235.1 | 205.5 | 87.4 | 93.3 | 68.9 |
| Example 2 | 236.9 | 207.5 | 87.6 | 92.9 | 63.7 |
| Example 3 | 234.7 | 202.5 | 86.3 | 93.6 | 33.3 |
| Example 4 | 236.8 | 206.3 | 87.1 | 93.2 | 30.9 |
| Comparative | 231.2 | 192.7 | 83.3 | 92.1 | 75.3 |
| Example 1 | | | | | |
| Comparative | 229.9 | 190.4 | 82.8 | 92.5 | 71.6 |
| Example 2 | | | | | |
| Comparative | 233.3 | 199.8 | 85.6 | 90.9 | 88.4 |
| Example 3 | | | | | |

As can be seen from Table 3 above, when using a cathode active material prepared using a precursor containing Al for the surface layer as in Examples 1 to 4, the efficiency characteristics are improved compared to Comparative Examples. This improvement in efficiency characteristics is considered to be because lithium can easily diffuse to the center portion due to the unique structure in which the Al compositions of the precursors prepared in Examples are different from each other. In addition, this structure suppresses cracking during charge/discharge and thus improves 50 cycle characteristics.

On the other hand, cathode active materials prepared using a precursor having no porous structure as in Comparative Examples 1 and 2 exhibit lower efficiency characteristics because lithium does not smoothly diffuse into the particles and also exhibit significantly lower lifespan characteristics due to particle cracking during charge/discharge. In Comparative Example 3, Al is present to the center portion and the efficiency characteristics are higher compared to Comparative Examples 1 and 2 due to the overall porous structure, but particle cracks occur more easily during charge/discharge, resulting in significantly lower lifespan characteristics.

This indicates that a precursor capable of preparing a cathode active material with improved efficiency and lifespan characteristics can be obtained only when the composition of the central and surface portions is controlled according to in the present invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A precursor for preparing a cathode active material comprising a center portion and a surface portion sequentially formed from a center of a particle toward an outer surface,
wherein the surface portion has a lower density than the center portion.

2. The precursor according to claim 1, wherein a difference in density between the surface portion and the center portion is caused by a difference in porosity therebetween.

3. The precursor according to claim 1, wherein the surface portion has a porous structure.

4. The precursor according to claim 1, wherein a density ratio of the surface portion to the center portion (surface portion density/center portion density) is in the range of 0.1 to 0.95.

5. The precursor according to claim 1, wherein the center portion comprises an element composition represented by the following Formula 1 and the surface portion comprises an element composition represented by the following Formula 2: 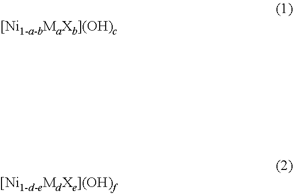
wherein a, b and c satisfy 0≤a≤1, 0≤b<0.5, and 1≤c≤3;
d, e and f satisfy 0≤d≤1, 0<e≤0.5, and 1≤f≤3;
b and e satisfy b<e;
M includes at least one transition metal element stable in 4-coordination or 6-coordination; and
X includes at least one element selected from the group consisting of Al, Zr, Mg, B, Ti, Zn, Sn, Ca, Ge, Ga, Nb, Mo, and W.

6. The precursor according to claim 1, wherein a material for the center portion comprises 50% or more of Ni, on a molar basis, based on a total content of elements excluding oxygen and hydrogen, and optionally comprises Mn and/or Co.

7. The precursor according to claim 1, wherein a material for the surface portion comprises 50% or more of Ni and 20% or less of an element X on a molar basis, based on a total content of elements excluding oxygen and hydrogen, and optionally comprises Mn and/or Co.

8. The precursor according to claim 5, wherein the element X is Al.

9. The precursor according to claim 5, wherein a content of element X in the surface portion is in the range of 1,000 to 10,000 ppm.

10. The precursor according to claim 5, wherein the center portion does not comprise element X.

11. The precursor according to claim 5, wherein the center portion comprise the element X in an amount of 1,000 ppm or less.

12. The precursor according to claim 5, wherein there is a discontinuous difference in a concentration of element X at an interface between the center portion and the surface portion.

13. The precursor according to claim 5, wherein the element X at the surface portion has the following concentration gradient:
(i) a concentration gradient in which the concentration increases toward the center of the precursor particle;
(ii) a concentration gradient in which the concentration decreases toward the center of the precursor particle;
(iii) a concentration gradient in which the concentration increases toward the center of the precursor particle and then decreases; or
(iv) a concentration gradient in which the concentration decreases toward the center of the precursor particle and then increases.

14. The precursor according to claim 13, wherein the difference in the concentration of element X between a maximum concentration region and a minimum concentration region in the surface portion on an average concentration basis is 5% or less.

15. The precursor according to claim 1, wherein a ratio of the center portion to the surface portion (center portion:surface portion) based on a diameter of the precursor particle is in the range of 3:7 to 9:1.

16. The precursor according to claim 15, wherein the ratio is in the range of 5:5 to 6:4.

17. A cathode active material prepared by mixing the precursor according to claim 1 with a lithium precursor, followed by firing.

18. A secondary battery comprising the cathode active material according to claim 17.
